(19) United States
(12) Patent Application Publication
(10) Pub. No.: US 2007/0277807 A1
(43) Pub. Date: Dec. 6, 2007

(54) Stovetop grill having heat distributing rotor

(76) Inventor: Vahid Taban, Santa Ana, CA (US)

Correspondence Address: LAW OFFICES OF MORLAND C FISCHER, 2030 MAIN ST, SUITE 1300, IRVINE, CA, 92614, US

(21) Appl. No.: 11/437,957

(22) Filed: May 22, 2006

(51) Int. Cl. F24C 1/16; A21B 1/52

(52) U.S. Cl. 126/275 R

(57) ABSTRACT

A stovetop grill having a rotatable turbine to diffuse and spread heat that is carried by hot gases across a cooking area of a grill platform so that food on the platform will be evenly cooked. The turbine includes a disk body that is mounted for rotation around an axis established by a turbine shaft. A plurality of relatively short impeller blades are spaced from one another around the circumference of the turbine body. A plurality of relatively long propeller blades are spaced from one another around the turbine body at a location that is radially inward from the impeller blades. The impeller and propeller blades are punched or cut out and bent upwardly from the turbine body to establish gas passages therethrough. The turbine is adapted to rotate relative to the grill platform in response to the hot gases that are generated by a heat source (e.g., a gas burner) and pass through the gas passages in the turbine body for imparting a spinning force against the propeller blades, whereby the impeller blades distribute the heat evenly across the cooking area.

### BACKGROUND OF THE INVENTION

1. Field of the Invention

This invention relates to a stovetop grill including a rotating turbine to diffuse and spread heat that is generated by a heat source (e.g., a gas burner) evenly across a cooking area. The stovetop grill herein disclosed may be used indoors on a standard kitchen range or outdoors with a gas barbeque and a portable camping grill.

2. Background Art

Charcoal grills are preferred primarily because they spread heat evenly and prevent direct flame contact with the food being cooked. Food is cooked by means of coming into contact with hot gases that rise above the hot charcoals (i.e., convection) in combination with the intense infrared energy that is emitted by the red hot charcoals (i.e., radiation). Provided that the charcoal grill is constructed properly and that charcoals are evenly distributed, the heat that is transferred by means of convection and radiation is uniformly distributed across the entire cooking area.

Direct flame contact should be avoided in order to properly cook food. Flames burn and char the exterior surface of the food while the inside often remains uncooked. The occasional flame bursts in charcoal grills are not as hot or concentrated as a characteristic blue flame from a typical gas grill and, therefore, may not be altogether reliable for completely cooking certain foods so as to be ideal for consumption.

Gas grills are easier to use, easier to clean, and more convenient than charcoal grills. However, such gas grills have relatively concentrated and intense flames which must be diffused. Many methods have been considered in the past to spread the heat evenly across the cooking area of both outdoor gas barbeques and stovetop grills. By way of example, perforated and formed metal sheets, layers of lava rocks, large oval burners, arrays of long burners, etc. have been employed in the past in an effort to spread the heat around the cooking area. However, because of their characteristic drawbacks, each of such heat spreading techniques has achieved only limited success in achieving the same convection and radiation heat transfer that is otherwise achieved by charcoal grills.

In view of the foregoing, what is desired is a simple to use stovetop grill having means by which to uniformly spread heat from a heat source over the cooking area so that both convection and radiation forms of heat transfer may be advantageously employed to reliably and more evenly cook food so as to be suitable for consumption.

### SUMMARY OF THE INVENTION

In general terms, a stovetop grill is disclosed which includes a rotatable turbine to diffuse and spread heat that is generated by a source of heat (e.g., a gas burner) across a grill platform on which food is laid so that the food will be evenly cooked throughout. The stovetop grill herein disclosed may be used indoors on a standard kitchen range or outdoors with a gas barbeque or a portable camping grill. The stovetop grill includes a pan having a gas intake hole formed therethrough and positioned above the heat source. Water is poured into a water trough of the pan that surrounds the intake hole so as to cool the pan during cooking. A cylindrical side wall is connected to and stands upwardly from the pan. The grill platform is supported at and adjustably positioned above the heat source at grill support slits that are formed in the side wall. A cover encloses the side wall and lies over top the grill platform to confine the heat to the interior of the stovetop grill.

The turbine is mounted for rotation within the side wall so as to lie below the grill platform and in axial alignment above the gas intake hole of the pan. A turbine support bar is welded across the gas intake hole of the pan. One end of a turbine shaft is affixed to the turbine support bar, and the opposite end is received within a turbine bushing. The turbine bushing is attached at the center of the turbine such that the turbine shaft establishes an axis around which the turbine and its bushing can rotate.

The turbine has a disk-shaped body. A first set of relatively short impeller blades are spaced from one another around the circumference of the turbine body. A second set of relatively long propeller blades are spaced from one another around the turbine body at a location that is radially inward from the impeller blades. The impeller and propeller blades are cut or punched out of the turbine body and bent upwardly therefrom to create a corresponding set of gas passages that communicate with respective ones of the blades. Hot gases from the source of heat pass through some of the gas passages in the turbine body to impart a spinning force against the propeller blades to cause the turbine to rotate. Hot gases also pass through the other gas passages to be diverted radially outward towards the side wall and over the grill platform. By virtue of the rotating turbine, the heat that is carried by the gases is evenly spread towards the edges of the grill platform to assure a uniform cooking temperature across the cooking area.

### BRIEF DESCRIPTION OF THE DRAWINGS

FIG. 1 is a side view of a stovetop grill and cover according to a preferred embodiment of this invention;

FIG. 2 is a top isometric view of the stovetop grill of FIG. 1 with the cover removed therefrom;

FIG. 3 is a bottom isometric view of the stovetop grill shown in FIG. 2;

FIG. 4 is an exploded view of the stovetop grill showing a turbine to be mounted for rotation on a turbine shaft between a pan and a grill platform;

FIG. 5 is a broken-away side view showing details of the pan and a cylindrical side wall connected to and standing upwardly therefrom;

FIG. 6 is an isometric view showing the turbine and a plurality of impeller and propeller blades projecting upwardly therefrom;

FIG. 7 is a top view of the turbine of FIG. 6 showing the disposition of the impeller and propeller blades thereof;

FIG. 8 is a cross-section of the turbine of FIG. 6 showing details of a turbine bushing attached at the center of the turbine to facilitate rotation thereof;

FIG. 9 is a cross-section of the stovetop grill of FIG. 1 showing the turbine supported for rotation on the turbine shaft; and

FIG. 10 is an enlarged detail taken from FIG. 9 to illustrate the turbine coupled to the turbine shaft by way of the turbine bushing.

### DESCRIPTION OF THE PREFERRED EMBODIMENT

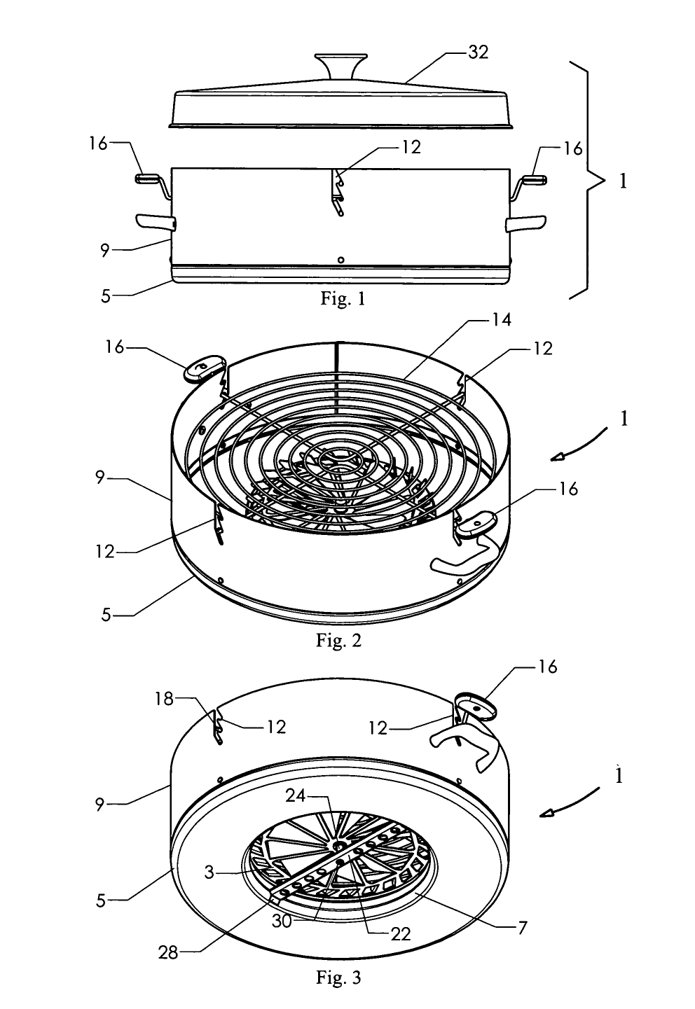

A preferred embodiment of the stovetop grill 1 which forms the present invention is initially described while referring to FIGS. 1-4 of the drawings. While the stovetop grill 1 herein disclosed has particular application for use indoors on top of a gas burner from a conventional kitchen range, it is to be understood that the teachings and advantages of this invention are also applicable to an outdoor gas barbeque and portable camping grill. Regardless of the type of indoor or outdoor heating source that is employed, the grill 1 includes a rotatable turbine 3 that is preferably disposed above a gas burner in order to evenly spread the heat generated by the burner across the cooking area.

The bottom of the stovetop grill 1 includes a circular pan 5 that is preferably manufactured from a thin sheet of metal. The pan 5 is formed with a raised gas intake hole 7 at the center that is typically 6 to 8 inches in diameter. A cylindrical side wall 9 of grill 1 is affixed (by means of rivets 10, or the like) to and stands upwardly from the pan 5. The side wall 9 is also preferably manufactured from thin sheet metal and has a plurality of (e.g., four) evenly spaced grill support slits 12 cut or punched out therefrom.

A grill platform 14 upon which food is cooked is preferably constructed from a series of concentric wire loops that are welded into a thicker set of pre-formed wires. A pair of grill handles 16 are affixed to and project outwardly from the wires of the grill platform 14 by way of a handle rod 18 that is sized to be removably received within one of the grill support slits 12 that is formed in the side wall 9 of stovetop grill 1. The grill support slits 12 are provided with a sawtooth configuration so that the height of the grill platform 14 above the heat source may be selectively adjusted depending upon the location of the handle rods 18 within respective slits 12.

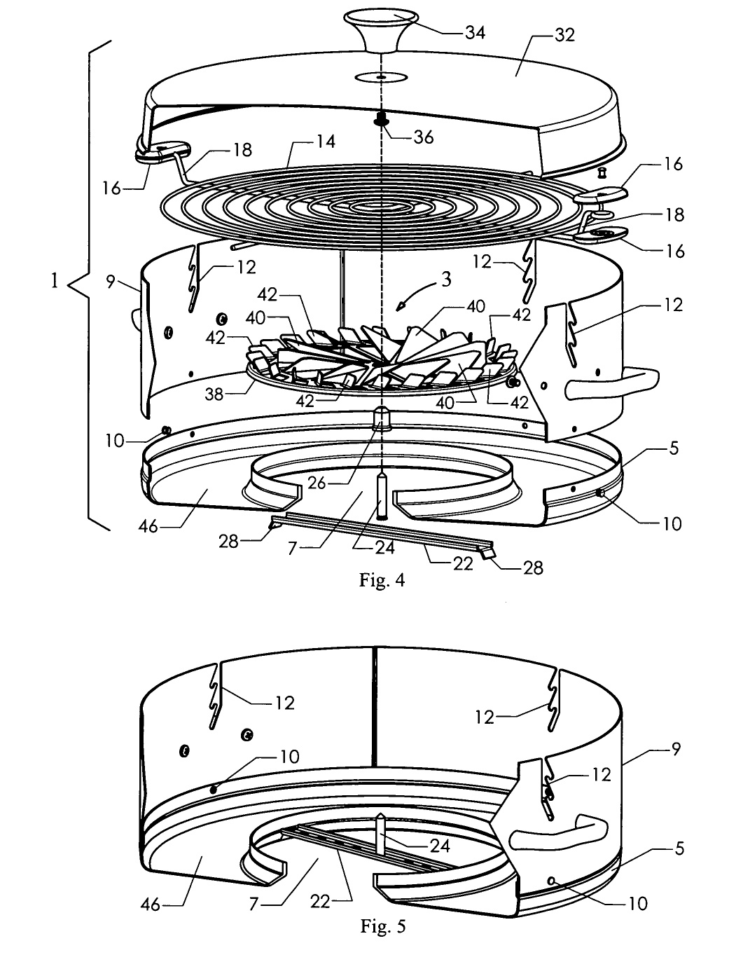

In accordance with the present improvement, the stovetop grill 1 includes a turbine 3 having a plurality of turbine blades 40 and 42 (to be described in greater detail hereinafter while referring to FIG. 6). The turbine 3 is supported from a turbine support bar 22 by way of a turbine shaft 24 and a turbine bushing 26 (best shown in FIG. 4). As is best shown in FIG. 3, the turbine support bar 22 is sized to be received within and welded across the gas intake hole 7 of the pan 5 of grill 1. To this end, tabs 28 are formed at opposite ends of the turbine support bar 22 to facilitate the welding process.

A mounting hole 30 (of FIG. 3) is formed in the turbine support bar 22 within which one end of the turbine shaft 24 is located. The first end of the turbine shaft 24 is affixed to support bar 22 by means of swaging, welding, or the like. FIG. 5 of the drawings shows the pan 5 connected in surrounding engagement with the side wall 9 with the turbine support bar 22 welded across the gas intake hole 7 and the turbine shaft 24 projecting upwardly from support bar 22 to be coupled to the turbine. Accordingly, the turbine 3 will be held in spaced axial alignment above gas intake hole 7.

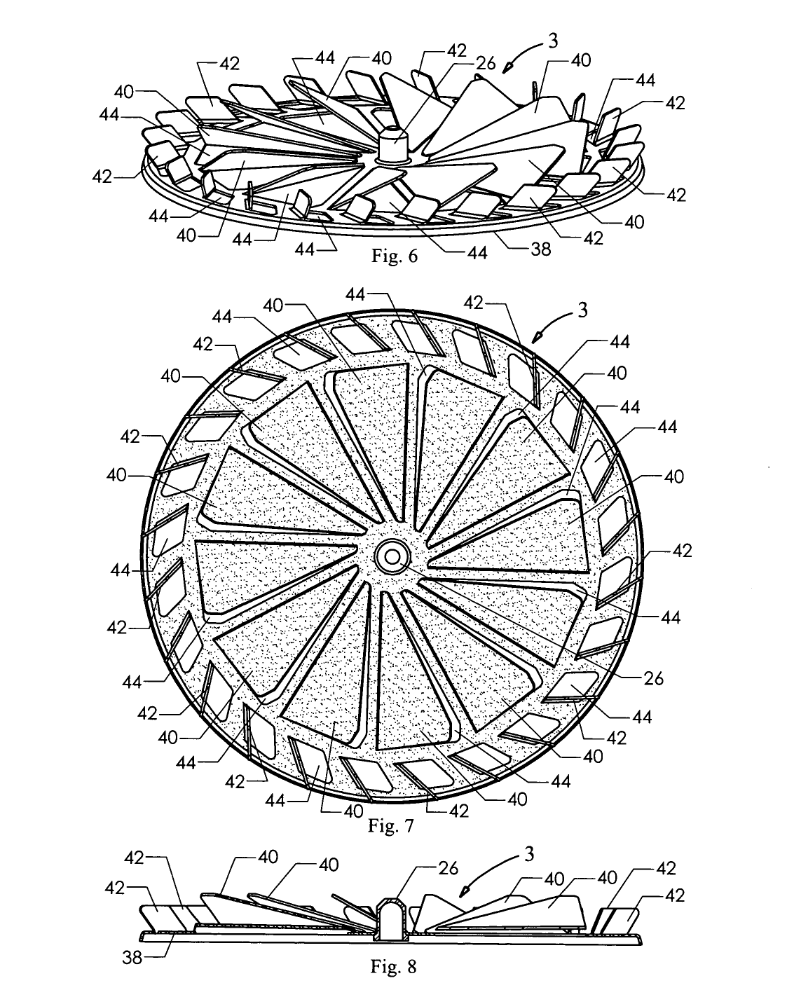

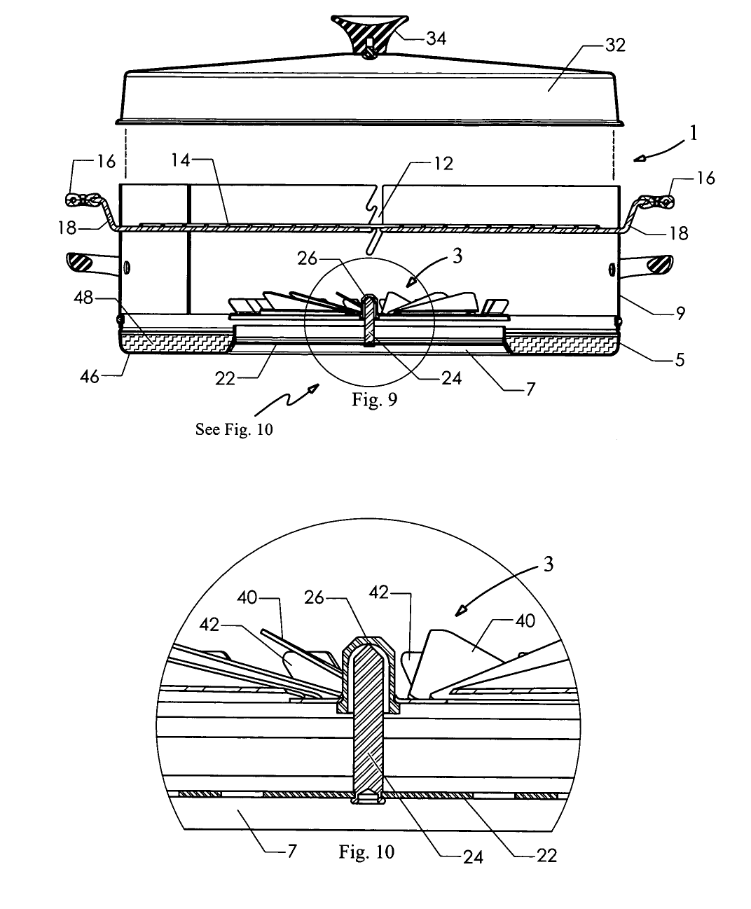

The turbine shaft 24 is preferably manufactured with a pointed tip formed at the end that lies opposite the first end thereof which is affixed to the mounting hole 28 of turbine support bar 22. As is best shown in FIG. 9, the pointed tip of turbine shaft 24 is removably received within the turbine bushing 26. The turbine bushing 26 is press fit into mating engagement with the turbine 3 through the center thereof. In the assembled relationship best shown in FIG. 8, the turbine shaft 24 establishes an axis around which the turbine 3 can rotate by virtue of the turbine shaft 24 extending between the turbine bushing 26 which carries turbine 3 and the turbine support bar 22 running across the gas intake hole 7 of pan 5 to support the weight of the turbine. To facilitate a smooth rotation of the turbine 3, the interior of the turbine bushing 26 is generally spherical at which to engage the pointed tip of the turbine shaft 24 (best shown in FIGS. 7 and 9).

The stovetop grill 1 includes a removable cover 32 to extend across and enclose the side wall 9 above the grill platform 14 so as to confine the heat generated by the heat source to the cooking area of the grill platform 14 on which food is cooked. The usual lifting knob 34 is attached to the cover 32 by means of a suitable fastener 36 (of FIG. 4).

Because the turbine support bar 22, the turbine shaft 24, the turbine bushing 26, and the turbine 3 will all be exposed to direct flames of the gas burner during the cooking operation, they are preferably manufactured from a high temperature alloy of stainless steel for maximum resistance to oxidation and scaling. The turbine shaft 24 and turbine bushing 26 may also be hardened to promote long life and friction free operation.

Details of the turbine 3 of stovetop grill 1 are now provided while referring to FIGS. 6-8 of the drawings. As was previously described, the turbine 3 is supported at a single point (i.e., the pointed tip of the turbine shaft 24 that is received within the generally spherical turbine bushing 26 in the manner shown in FIG. 10). Therefore, the turbine 3 and the bushing 26 mated thereto are adapted to spin freely and with minimal friction around the axis that is established by the turbine shaft 24.

The turbine 3 is preferably formed from a thin sheet of metal. The turbine bushing 26 is press fit to the turbine 3 via a central hole (best shown in FIG. 8) therethrough such that the bushing 26 and turbine 3 are coaxially aligned. Nevertheless, it should be understood that the turbine bushing 26 may also be welded to the turbine 3 so as to receive therewithin the pointed tip of the turbine shaft 24, whereby the shaft 24 is coupled to the turbine 3 at the bushing 26 to permit the turbine 3 to rotate within the stovetop grill 1 during the cooking operation in a manner that will soon be described.

The turbine 3 has a disk-shaped body 38 that includes a series of relatively long propeller blades or fins 40 and a series of relatively short impeller blades or fins 42 that are punched from the turbine body 38 to create gas flow passages 44 therethrough. The impeller blades 42 extend around the outer periphery (i.e., circumference) of the turbine body 38, and the propeller blades 40 are spaced radially inward therefrom. As is best shown in FIGS. 6 and 7, propeller blades 40 are bent to extend over respective gas flow passages 44 to interact with gases flowing in a direction which is parallel to the axis of rotation established by the turbine shaft 24 (of FIG. 10). The impeller blades 42 stand upwardly from the turbine body 38 alongside respective gas flow passages 44 so as to divert the gases through gas flow passages 44 radially outward towards the side wall 9 of the stovetop grill in a direction which is perpendicular to the axis of rotation established by the turbine shaft 24. Although the propeller and impeller blades 40 and 42 are shown projecting from the top of the disk-shaped body 38 of turbine 3, such blades may also be located around the side of the body 38 (e.g., with short cylindrical or conical configurations).

As is also best shown in FIGS. 6 and 7, the propeller blades (or fins) 40 are angled above the gas flow passages 44 so that the rising flames and hot gases cause the turbine 3 to spin in a clockwise direction. Depending upon the angle of the propeller blades 40 and the temperature of the flames, the turbine 3 may reach a rotational speed of a few hundred RPM. The rotation of the turbine 3 interrupts the flame and creates a spiral of hot gases in the center of the cooking area at the grill platform (designated 14 in FIG. 4). The upstanding impeller blades (or fins) 42 around the outer periphery of the turbine body 38 do not affect the rotation of the turbine 3, but act to spread the heat evenly across and towards the edges of the cooking area. That is, without the impeller blades 42, the center of the cooking area would typically be much hotter than the temperature at its outer edges.

FIG. 9 of the drawings shows the pan 5 of the stovetop grill 1 including a trough 46 formed therein and running around the gas intake hole 7 thereof. Approximately ½ inch of water 48 (e.g., about 1 or 2 cups) are poured into the trough 46 of pan 5 to reduce the temperature of the pan 5 and the side wall 9 connected thereabove during cooking. Nevertheless, the turbine 3 may reach a high temperature which provides for a substantial amount of infrared radiation to aid in the cooking process.

During operation with the stovetop grill 1 of this invention mounted above a gas burner (not shown), a rapid rotation of the turbine 3 reduces any hot or cold spots that might occur within the cooking area of the grill platform 14. Therefore, food laid upon the grill platform 14 will cook evenly without a charred outer surface. The heat intensity can be selectively controlled by adjusting the height of the grill platform 14 above the burner within the grill support slits 12 in the manner previously described.

Conventional grill designs allow drippings to burn slowly due to contact with hot surfaces or flames at the bottom of the grill. Consequently, much smoke is generated by the conventional grill. Moreover, the burnt and hardened drippings make the grill pan difficult to clean. Contrary to the conventional grill configuration and shortcomings, the water 48 that is poured into the trough 46 around the gas intake hole 7 of pan 5 of stovetop grill 1 keeps the pan 5 and side wall 9 cool. Accordingly, any grease or bits of food that might fall down through the grill platform 14 will not burn so as to minimize the production of smoke. What is more, any grease or food bits that falls onto the turbine 3 will burn rapidly or simply fly off the turbine due to the centrifugal forces that are created as the turbine rotates. The high temperature to which the turbine 3 is heated often incinerates grease and food particles, whereby the turbine is easier to clean. Cleaning of the stovetop grill of the present invention is further simplified inasmuch as the turbine 3, the pan 5, the grill platform 14, and the cover 32 may all be easily disassembled and separated from one another.

The turbine 3 herein disclosed for the stovetop grill 1 provides a unique means of diffusing the heat that is generated by a gas burner. The gyroscopic forces that are created during rotation stabilize the turbine 3 and prevent it from wobbling. The turbine 3 of this invention is better able to center itself automatically by virtue of the interface of the pointed tip of the turbine shaft (24 of FIG. 10) with the spherical interior of the turbine bushing 26.

The benefits of the turbine 3 herein disclosed as a heat spreader may be advantageously employed for outdoor grills as well as indoor stovetop applications. In this case, the burners would be integrated at the bottom of the pan. The heat generated by the burners will be uniformly spread around the cooking area. In fact, smaller burners can be used in combination with the turbine 3 to cover a larger cooking area than that which is usually available with conventional outdoor grills. For larger outdoor barbeque applications, multiple burners and turbines may be employed. However, filling the pan 5 with water (48 in FIG. 9) will not be necessary for the outdoor grill configuration and, therefore, may be omitted.

1. A grill for cooking food, said grill to be located above a source of heat and comprising:
a pan;
a side wall connected to and standing upwardly from said pan;
a grill platform supported at said side wall upon which the food to be cooked is laid; and
a turbine surrounded by said side wall and located above said pan and below said grill platform, said turbine having a plurality of blades and a plurality of heat passages communicating with said blades, said turbine adapted to rotate relative to said grill platform in response to hot gases generated by the source of heat and passing through said heat passages for imparting a spinning force against said blades, the blades of said rotating turbine also diffusing and spreading the heat carried by the hot gases across the grill platform so that the food on said grill platform will be evenly cooked.

2. The grill recited in claim 1, wherein said pan has a gas intake hole extending therethrough, such that the gases generated by the source of heat pass through said gas intake hole to be supplied to the plurality of blades of said turbine by way of said plurality of gas passages communicating therewith.

3. The grill recited in claim 2, wherein said pan has a water trough surrounding said gas intake hole, said water trough receiving a supply of water for cooling said pan and said side walls standing upwardly therefrom.

4. The grill recited in claim 2, further comprising a turbine shaft extending from said pan to said turbine for supporting said turbine above said pan and establishing an axis around which said turbine rotates in response to the hot gases generated by the source of heat imparting said spinning force against said plurality of blades.

5. The grill recited in claim 4, further comprising a turbine support bar extending across the gas intake hole of said pan, one end of said turbine shaft coupled to said turbine support bar and the opposite end coupled to said turbine for supporting said turbine for rotation above and in axial alignment with said gas intake hole.

6. The grill recited in claim 5, further comprising a turbine bushing connected to said turbine and surrounding the opposite end of said turbine shaft, said turbine and said turbine bushing rotating around the turbine shaft at said opposite end thereof.

7. The grill recited in claim 1, wherein a first set of said plurality of blades are spaced from one another around the periphery of said turbine.

8. The grill recited in claim 7, wherein a second set of said plurality of blades are spaced from one another around said turbine inwardly of said first set of blades.

9. The grill recited in claim 8, wherein said first set of blades are impeller blades and said second set of blades are propeller blades, said propeller blades being angled over respective ones of said plurality of heat passages to receive said spinning force thereagainst for causing said turbine to rotate, and said impeller blades standing alongside respective other ones of said plurality of heat passages for diffusing and spreading the heat across the grill platform.

10. The grill recited in claim 9, wherein said propeller blades are longer than said impeller blades.

11. The grill recited in claim 8, wherein said turbine includes a turbine body, said first and second sets of blades being removed from and turned upwardly from said turbine body to establish said plurality of heat passages communicating with said first and second sets of blades.

12. The grill recited in claim 11, wherein said turbine body is a disk, said first set of blades being spaced from one another around the circumference of said disk, and said second set of blades being spaced from one another around said disk at a location that is radially inward from said first set of blades.
